(19) United States
(12) Patent Application Publication
(10) Pub. No.: US 2005/0154518 A1
(43) Pub. Date: Jul. 14, 2005

(54) Method and system for automatically scanning a side view mirror of a vehicle

(76) Inventors: Mao-Lien Huang, Taipei (TW); Tung-Pao Lo, Taipei (TW); Fan-Dwo Hsieh, Taipei (TW); Hsien-Tsung Tou, Taipei (TW)

Correspondence Address: MAO-LIEN HUANG, P.O. BOX 26-757, TAIPEI, 106, TW

(21) Appl. No.: 10/760,074

(22) Filed: Jan. 14, 2004

(51) Int. Cl. G05D 1/00

(52) U.S. Cl. 701/49; 701/1

(57) ABSTRACT

A method for automatically scanning a side view mirror of a vehicle maintains an original state of the side view mirror during driving and sends a control signal via a turning-signal processing unit or a steering-wheel processing unit to determine which side view mirror to scan. The selected side view mirror is driven to scan automatically in real time. A steering wheel or and a front tire is returned to a predetermined angle. The side view mirror returns to the original state thereof simultaneously.

### BACKGROUND OF THE INVENTION

1. Field of the Invention

The present invention relates to a system of a side view mirror, and particularly relates to a method and a system for automatically scanning a side view mirror of a vehicle.

2. Background of the Invention

Researchers and the car companies try to make improvements in conventional side view mirrors by various solutions and approaches. Areas for improvement include, for example, adding safety factors for driving, especially in lane changing, parallel driving, turning around, backing up or driving at high speeds. Additionally, it is desirable to avoid tiredness overcoming the driver and to make the driver adapt himself to the different circumstances. Improvements of the conventional side view mirrors need to satisfy a minimum of certain conditions, to reflect objects correctly with no distortion or little distortion, to embrace as large a visibility field as possible, and to eliminate the blind spot.

With respect to FIG. 1, an application with conventional side view mirrors includes a car 30a, a rear view mirror 20a disposed in a middle front zone of an interior of the car 30a, and two side view mirrors 10a respectively arranged on two lateral sides of a front zone of the car 30a. A direct vision A for a driver inside the car 30a via his eyes, an indirect vision B for the driver by reflection from the rear view mirror 20a, and an indirect vision C for the driver by reflection from the two side view mirrors 10a, are combined to provide a whole vision. A blind spot D, however, still exists, and may cause a greater frequency of accidents.

Solutions to the conventional side view mirrors include enlarging the size thereof, using convex mirrors or mirrors with gradually various curvatures, and adjusting mirrors by electrical connections. Each has its own drawbacks. Enlarging the size of the conventional side view mirror makes visual checks difficult. Convex mirrors increase the visibility field thereof but do not reflect real objects and real distances behind. Furthermore, the more convex the mirror is, the more distorted the reflection is and the more difficult it is to judge the distances of the objects. A mirror with various gradated curvatures can reflect real images and distances, and enlarge the visual zone, but they are difficult to manufacture. A mirror adjusted by an electrical connection provides hands-free adjustment to the driver, but blind spot D still exists at different dead angles.

FIGS. 2 and 3 show dead angles situations respectively occurring due to tire differences of a mobile 31a and a large vehicle 32a. Because of a track 41a (43a) of a front tire thereof and a track 42a (44a) of a rear tire thereof along an inner side are different from each other, a various distance spacing between the track 41a (43a) and the track 42a (44a), according to the mobile 31a in FIG. 2 (the large vehicle 32a in FIG. 2). How large the dead angle sights are is determined by how far the rear tire is from the front tire and how many degrees the front tire turns, accompanied by how dangerous the driver is.

Hence, an improvement over the prior art is required to overcome the disadvantages thereof.

### SUMMARY OF INVENTION

The primary object of the invention is therefore to specify a method and a system for automatically scanning a side view mirror of a vehicle to provide a good visibility field that is as large as possible by automatically scanning to diminish a blind spot, so that a driver can make good visual checks for objects originally hidden in the blind spot and drive safely.

According to the invention, this object is achieved by a method and a system for automatically scanning a side view mirror of a vehicle. The method includes a method for automatically scanning a side view mirror comprising holding an original state of the side view mirror during driving, setting a control signal via a turning-signal processing unit or a steering-wheel processing unit to select which side view mirror to scan, automatically scanning the selected side view mirror in real time, returning a steering wheel or and a front tire to a predetermined angle; and restoring the side view mirror comes to the original state thereof simultaneously.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view according to conventional side view mirrors with a blind spot;

FIG. 2 is a perspective view according to a dead angle sight due to tire differences of a mobile;

FIG. 3 is a perspective view according to a dead angle sight due to tire differences of a large vehicle;

FIG. 4 is a flow chart of a side view mirror automatic scanning method according to the present invention;

FIG. 5 is a perspective view of the side view mirror automatic scanning system according to the present invention; and

FIG. 6 is perspective view of the side view mirror automatic scanning system with an enlarged visibility field according to the present invention.

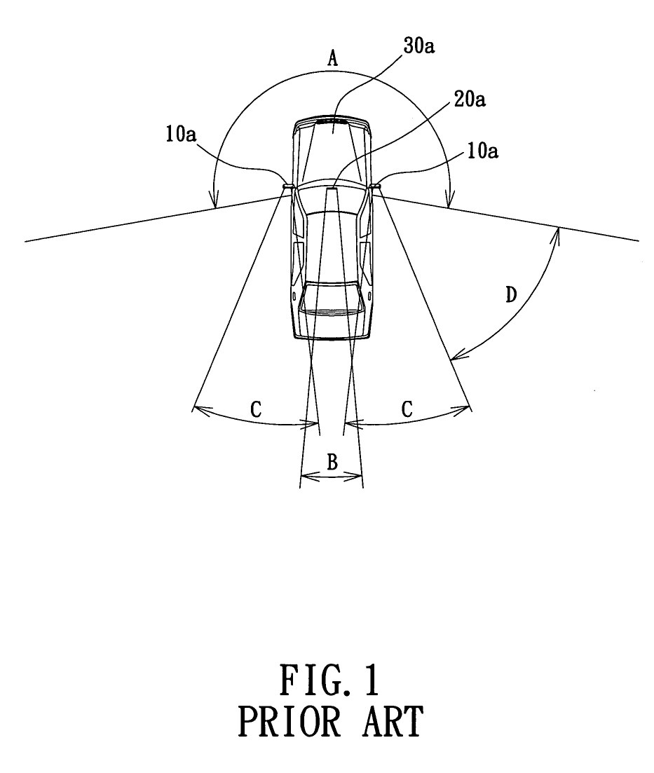

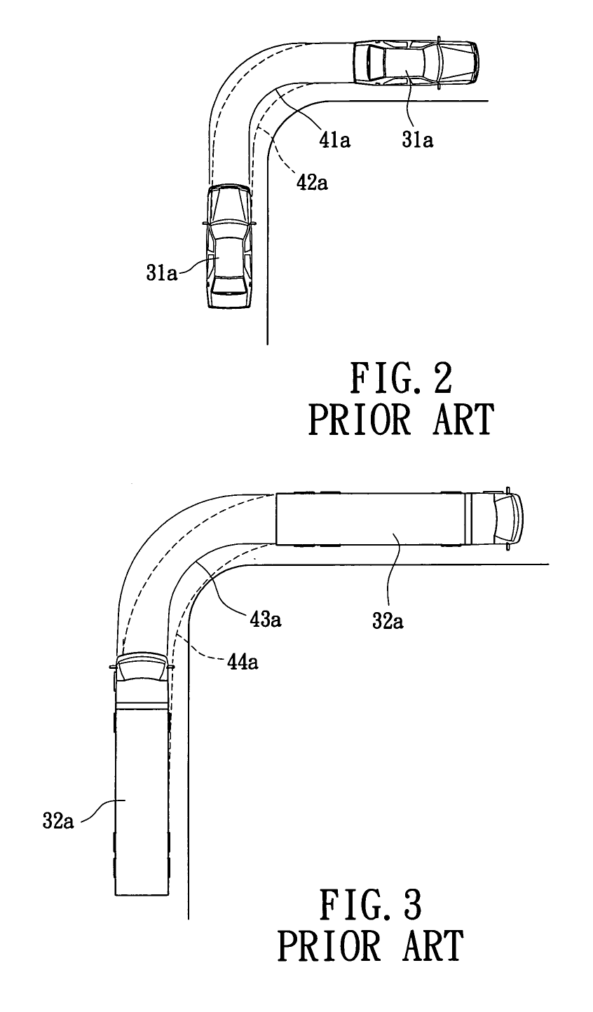

### DETAILED DESCRIPTION OF THE EMBODIMENTS

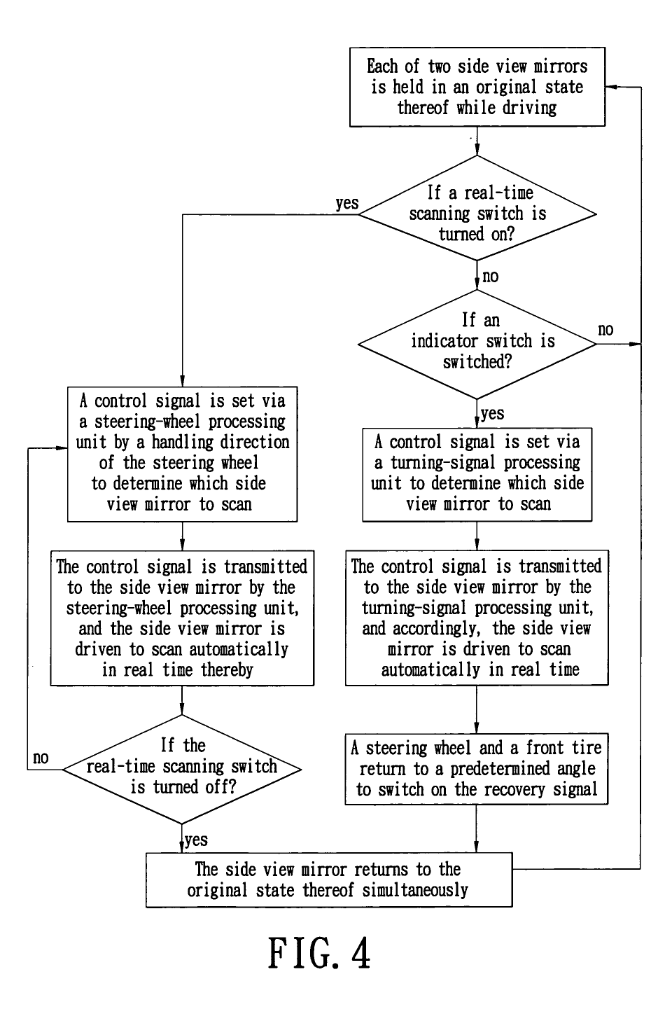

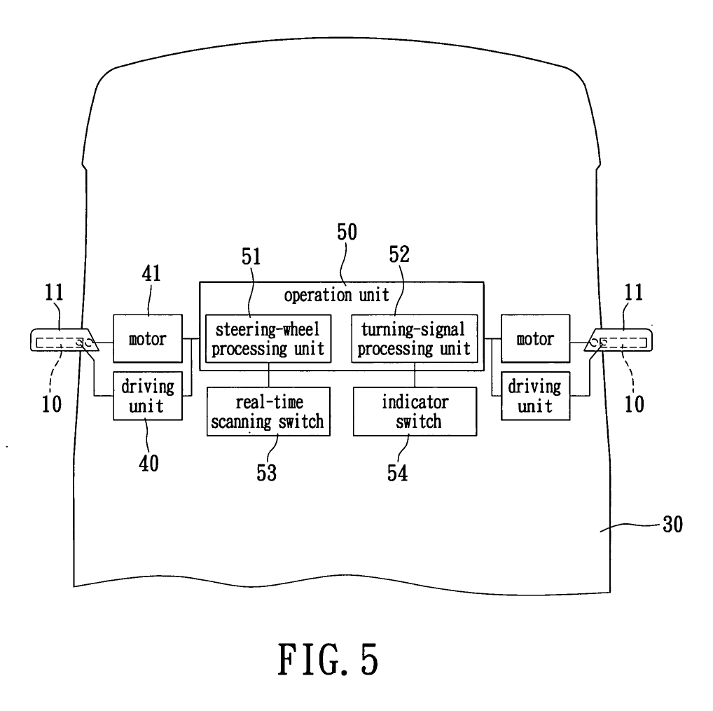

Referring to FIG. 4, the present invention provides a first method for automatically scanning a side view mirror of a vehicle. Each of two side view mirrors is held in an original state thereof during driving, and an indicator switch is switched when turning around or changing lanes. The indicator switch electrically connects the turning-signal processing unit, a control signal is set via a turning-signal processing unit to determine which side view mirror to scan, and the control signal and the side view mirror are determined by a switching direction due to the indicator switch. The control signal is transmitted to the side view mirror by the turning-signal processing unit, and accordingly, the side view mirror is driven to scan automatically in real time. A steering wheel and a front tire return to a predetermined angle to switch on the recovery signal after turning around or changing lanes. A recovery signal is delivered to the side view mirror and the side view mirror returns to the original state thereof simultaneously.

The present invention also provides second method for scanning objects in a rear zone in real time to keep driving carefully, and not particularly during turning around or changing lanes. Each of two side view mirrors is held in the original state thereof while driving. A real-time scanning switch is turned on to prepare for providing automatic scanning. A steering wheel is handled then and the control signal is accordingly set via a steering-wheel processing unit to determine which side view mirror to scan. The control signal and the side view mirror are determined by a handling direction of the steering wheel. The control signal is transmitted to the side view mirror by the steering-wheel processing unit, and the side view mirror is driven to scan automatically in real time thereby. The real-time scanning switch is turned off to deliver a recovery signal to the side view mirror after the driving situation is safe, and the side view mirror returns to the original state thereof simultaneously.

The present invention provides the methods to scan automatically the rear zone with the side view mirror in real time, so that the blind zone is reduced and the driver can make good visual checks of objects, which are originally hidden in the blind spot, and drive safely. When the indicator switch is pulled up or pushed down, the side view mirror, which is determined by the switching direction, is accordingly switched to scan automatically at various angles from the original state. The blind zone D is thus reduced as much as possible, the indirect field C is increased, and the driver can check if there is any object hidden in the blind zone D. After turning around or changing lanes, the steering wheel and the front tire return to the predetermined angle, and the recovery signal is transmitted to the side view mirror to return the side view mirror to the original state. When the driver drives on a winding road or along through the woods or mountains, the driver needs to know what is going on in the rear zone. Thus, the driver can turn on the real-time scanning switch and adjust the steering wheel and then, according to the turning direction of the steering wheel, the steering-wheel processing unit provides the control signal to the determined side view mirror for automatically scanning various angles. When the road is safe, the driver can turn off the real-time scanning switch to return the determined side view mirror to the original state thereof.

Each conventional side view mirrors 10a is combined with a driver seat, the steering wheel and the rear view mirror 20a in a mirror memorization system. The memorization system provides comforts adaptable to any height or habit. The method for the automatically scanning side view mirror of the present invention can be provided with the memorization system, and thus the side view mirror can return to the best mode stored in the memorization system after automatically scanning.

The present invention provides a system for an automatically scanning side view mirror of a vehicle. The system includes at least two side view mirrors 10 disposed respectively on two lateral sides of a vehicle 30, at least two driving units 40 respectively electrically connecting the two side view mirrors 10, and an operation unit 50 electrically connecting the two driving units 40. The operation unit 50 includes a turning-signal processing unit 52 and a steering-wheel processing unit 51. The system further includes an indicator switch 54 electrically connecting the turning-signal processing unit 52, whereby each of the two side view mirrors 10 is determined to be driven according to a switching direction of the indicator switch 54. Alternatively, the system further includes a real-time scanning switch 53 electrically connecting the two driving units 40 and the steering-wheel processing unit 51, whereby each of the two side view mirrors 10 is determined to be driven according to a handling direction of a steering wheel, which connects the steering-wheel processing unit 51. The system determines which side view mirror 10 to scan automatically by the turning-signal processing unit 52 or the steering-wheel processing unit 51 according to different cases, and sends a control signal to each of the driving units 40 of the side view mirror 10.

In addition, the system further includes a bracket 11 protecting each of the two side view mirrors 10 and a motor 41 driving the bracket 11 to rotate. The motor 41 electrically connects the operation unit 50, so that the bracket 11 is driven by the motor 41 thereof and the side view mirrors 10 are respectively driven by the driving units 40. The bracket 11 and each of the two side view mirrors 10 are independently driven from each other, and are capable of wide-scanning in a cooperation manner for diminishing a blind spot D while driving. A reflection zone of the blind spot D is variable according to the design ability and manufacturing capability.

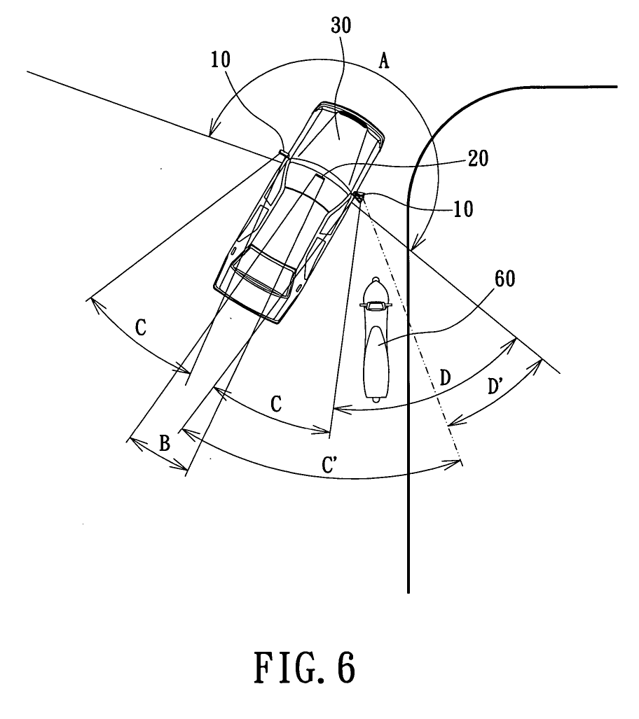

With respect to FIG. 6, the system further includes a rear view mirror 20 disposed in a middle front zone of an interior of the vehicle 30. The driver sees a direct vision A via his eyes directly, an indirect vision B by reflection from the rear view mirror 20a and an indirect vision C′ by reflection from the two side view mirrors 10. The direct vision A, the indirect vision B and the indirect vision C′ are combined to provides a whole vision excepting a blind spot D′. The blind spot D′, excluding a zone with a motorbike 60 therein, is smaller than the blind spot D, including a zone with a motorbike 60 therein and occurring with the conventional side view mirror 10a. The driver is provided with an improved visibility field that is as large as possible by automatic scanning.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A method for automatically scanning a side view mirror of a vehicle, comprising:
(a) maintaining an original state of each of two side view mirrors while driving;
(b) switching an indicator switch and sending a control signal via a turning-signal processing unit to determine which side view mirror to scan, wherein the indicator switch electrically connects the turning-signal processing unit, and the control signal and the side view mirror are determined by a switching direction due to the indicator switch;
(c) transmitting the control signal to the side view mirror by the turning-signal processing unit;
(d) driving the side view mirror to scan automatically in real time; and
(e) delivering a recovery signal to the side view mirror, wherein the side view mirror returns to the original state thereof simultaneously.

2. The method claimed as claim 1, further including providing a steering wheel and a front tire thereof back with a predetermined angle to switch on the recovery signal after step (d).

3. A method for automatically scanning a side view mirror of a vehicle, comprising:
(a) maintaining an original state of each of two side view mirrors while driving;
(b) turning on a real-time scanning switch to be ready for providing automatic scanning;
(c) handling a steering wheel and sending a control signal via a steering-wheel processing unit to determine which side view mirror to scan, wherein the control signal and the side view mirror are determined by a handling direction of the steering wheel;
(d) transmitting the control signal to the side view mirror by the steering-wheel processing unit;
(e) driving the side view mirror to scan automatically in real time; and
(f) turning off the real-time scanning switch to deliver a recovery signal to the side view mirror, wherein the side view mirror returns to the original state thereof simultaneously.

4. A system for automatically scanning a side view mirror of a vehicle, comprising:
at least two side view mirrors disposed respectively on two lateral sides of a vehicle;
at least two driving units respectively electrically connecting the two side view mirrors; and
an operation unit electrically connecting the two driving units, wherein the operation unit includes a turning-signal processing unit and a steering-wheel processing unit;
whereby the system determines which side view mirror to scan automatically by the turning-signal processing unit and the steering-wheel processing unit according to different cases, and send as control signal to each of the driving units of the side view mirror.

5. The system claimed as claim 4, further including an indicator switch electrically connecting the turning-signal processing unit, whereby each of the two side view mirrors is determined to be driven according to a switching direction of the indicator switch.

6. The system claimed as claim 4, further including a real-time scanning switch electrically connecting the two driving units and the steering-wheel processing unit, whereby each of the two side view mirrors is determined to be driven according to a handling direction of a steering wheel, wherein the steering wheel connects the steering-wheel processing unit.

7. The system claimed as claim 4, further including a bracket protecting each of the two side view mirrors and a motor driving the bracket to rotate, wherein the motor electrically connects the operation unit, the bracket is driven by the motor thereof and the side view mirrors are respectively driven by the driving units, and the bracket and each of the two side view mirrors are independently driven from each other and are capable of wide-scanning in a cooperative manner for diminishing a blind spot while driving.
